(19) United States
(12) Patent Application Publication
(10) Pub. No.: US 2026/0019252 A1
(43) Pub. Date: Jan. 15, 2026

(54) AUTHENTICATION METHOD FOR AVOIDING EMERGENCY VEHICLES

(71) Applicant: Hangzhou Normal University, Hangzhou (CN)

(72) Inventors: Qi Xie, Hangzhou (CN); Juanjuan Huang, Hangzhou (CN); Xiumei Li, Hangzhou (CN); Qingyun Xie, Hangzhou (CN); Yining Liu, Hangzhou (CN); Anjia Yang, Hangzhou (CN)

(21) Appl. No.: 19/019,493

(22) Filed: Jan. 14, 2025

(30) Foreign Application Priority Data
Jul. 11, 2024 (CN) 202410931184.7

(51) Int. Cl. H04L 9/14; H04L 9/30

(52) U.S. Cl. CPC H04L 9/14; H04L 9/3066

(57) ABSTRACT

The proposed invention discloses an authentication scheme for avoiding emergency vehicles. Emergency vehicles send accident rescue route information and authentication message requests to the nearest roadside unit (RSU). Upon receiving the message, the RSU verifies the legitimacy of the vehicle's identity and generates shared secret values, which are encrypted and sent to the emergency vehicle. Simultaneously, the RSU forwards the avoidance route message, partial vehicle information, and the shared secret values to the second RSU along the rescue route. When the emergency vehicle reaches the second RSU, it sends a request for authentication to the RSU. Upon successful authentication, new shared secret values are generated, encrypted, and sent to the emergency vehicle. Simultaneously, the avoidance route message, partial vehicle information, and the newly generated shared secret values are passed on to the next RSU along the rescue route. The subsequent authentication process follows the same method as described for the second authentication.

### TECHNICAL FIELD

The proposed invention belongs to the field of information security technology and specifically relates to an authentication method for avoiding emergency vehicles.

### BACKGROUND

Against the backdrop of rapid socio-economic and technological development, urban populations and vehicles have been growing rapidly. This rapid growth has resulted in recurring issues such as traffic congestion, traffic accident rescue, and traffic management, posing common challenges for countries worldwide. In order to address these transportation issues, Intelligent Transportation Systems (ITS) have been proposed and gained significant attention. The Internet of Vehicles (IoV) is an integral component of ITS and has been widely implemented in smart cities in recent years. IoV refers to the interconnection of vehicles with the internet through wireless communication technologies, enabling real-time data exchange and communication between vehicles, the external environment, other vehicles, and infrastructure. By utilizing technologies such as onboard sensors and communication modules, vehicles are transformed into intelligent terminals that facilitate seamless connectivity and communication between vehicles and infrastructure.

### SUMMARY

The proposed invention provides an authentication method for avoiding emergency vehicles, addressing the issue of emergency lane occupation in current emergency vehicle rescue scenarios using IoV technology to improve rescue efficiency. However, IoV communication over wireless channels faces a series of security challenges, such as eavesdropping, forgery, and tampering of messages. In particular, in emergency vehicle passage scenarios, there is a susceptibility to various attacks, such as adversaries impersonating emergency vehicles for communication to gain road priority. To ensure the security of information transmission, authentication between vehicles and infrastructure is crucial. Employing authentication protocols can mitigate risks during vehicle-to-roadside unit communication and thwart malicious attacks, such as impersonation attacks, forgery attacks, side-channel attacks, and so on.

The protocol is based on elliptic curve cryptography and achieves conditional privacy protection and mutual authentication. The proposed protocol allows emergency vehicles to perform fast authentication with subsequent roadside units after completing the initial mutual authentication with the nearest roadside unit, avoiding cumbersome computation processes. Additionally, each roadside unit broadcasts avoidance information to regular vehicles within its jurisdiction in advance, reminding them to create temporary emergency lanes for the emergency vehicles. Furthermore, the protocol introduces legitimacy verification of the driver's identity upon the initiation of an emergency vehicle, enabling the trusted authority to hold malicious behavior accountable. The design also incorporates physical unclonable functions and biometric keys to protect the privacy information of roadside units and emergency vehicles, mitigating the risk of secret key leakage.

The technical solution of the proposed invention is as follows:

The authentication method for avoiding emergency vehicles, comprises the following steps:

S1, during the system initialization phase, the trusted authority (TA) selects an elliptic curve, generates public and private keys, and handles registration requests from emergency vehicles and roadside units.

S2, the trusted authority (TA) is responsible for generating registration information for both emergency vehicles and roadside units, and providing feedback of the registration information to the vehicles and roadside units. Upon receiving the registration information, the vehicles and roadside units utilize their unique physical unclonable functions to calculate secret parameters. The calculated registration information is then separately stored in the onboard unit (OBU) of the vehicle and the storage unit of the roadside unit.

S3, after an accident occurs, the emergency vehicle proactively sends accident rescue route information and an authentication request to the nearest roadside unit. Upon receiving the message, the roadside unit first verifies the legitimacy of the vehicle's identity. If the authentication is successful, the roadside unit sends the avoidance message in advance to all regular vehicles within its jurisdiction, prompting them to make timely evasive maneuvers and clear the emergency lane. Simultaneously, the roadside unit generates shared secret values, encrypts them, and sends them to the emergency vehicle. This is achieved using elliptic curve Diffie-Hellman (ECDH) values, hash algorithms, and symmetric encryption algorithms. Additionally, the roadside unit transmits the avoidance message, partial vehicle information, and the shared secret values to the next roadside unit along the rescue route.

S4, when the emergency vehicle reaches the second roadside unit, it sends an authentication request to the roadside unit. The second roadside unit performs the authentication process, and upon successful authentication, generates new shared secret values. This new shared secret values are encrypted and sent to the emergency vehicle. Simultaneously, the second roadside unit passes on the avoidance message, partial vehicle information, and the newly generated shared secret values to the next roadside unit along the rescue route. This process continues until the emergency vehicle reaches the accident scene.

Furthermore, a trusted authority (TA) selects a large prime number p, a finite field Fₚ, an elliptic curve E:y²=x³+ax+b (mod p), where a, b ∈ Fₚ. The group G of the curve has an order q, and P is a generator. Additionally, a secure one-way hash function h(·) is chosen. A random number s ∈ Z*_{q} is selected as the private key of the system, and the corresponding public key is computed as the point multiplication result using the elliptic curve algorithm, denoted as

$$P {K}_{T A} = s \cdot P .$$

Furthermore, the specific details of S2 are as follows:

S2.1, Roadside Unit Registration. Firstly, the trusted authority (TA) generates timestamps T_{Rn}={T_{R1}, T_{R2} . . . , T_{Rn}} for each roadside unit RSUₙ={RSU₁, RSU₂, RSU₃, . . . , RSUₙ}. Simultaneously, it selects private keys uₙ ∈ Z*_{q} for each roadside unit and computes the corresponding public keys PK_{RSUn}=uₙ·P using elliptic curve point multiplication. Next, the TA sends the private key uₙ, public key PK_{RSUn}, and timestamp T_{Rn} to each roadside unit RSUₙ. The roadside unit RSUₙ randomly selects a challenge value Cₙ and uses a physical unclonable function (PUF) to generate the corresponding response value Rₙ=PUF(Cₙ). It then computes sk_{RSUn}=uₙ ⊕ h(Rₙ∥TRₙ) to encrypt and store the long-term private key uₙ. Finally, the roadside unit stores the tuple <Cₙ, sk_{RSUn}, PK_{RSUn}, T_{Rn}>in its storage unit. Meanwhile, the TA publishes the system parameters params={G, E, P, p, q, a, b, h(·), PK_{TA}, PK_{RSUn}} for all entities.

S2.2, Emergency Vehicle and Driver Registration. The driver Drᵢ of the emergency vehicle EVⱼ selects an identity ID_{EVj} and inputs his/her biometric information BIOᵢ; to EVⱼ. EVⱼ generates its private key vⱼ ∈ Z*_{q} and computes the public key PK_{Evj}=vⱼ·P using elliptic curve algorithm. Using the fuzzy extractor's generation function Gen (BIOᵢ)={aᵢ, βᵢ}, the biological key aᵢ and recovery parameter βᵢ are computed. EVⱼ sends {PK_{EVj}, ID_{EVj}} to the trusted authority (TA) through a secure channel. The TA generates the current timestamp T₁, two random numbers xⱼ and bⱼ, and computes Xⱼ=xⱼ·P using elliptic curve algorithm. Using the system key s, it encrypts and generates the pseudonym of the emergency vehicle EVⱼ as PEVⱼ=Eₛ(ID_{EVj}∥bⱼ∥T₁). The identity verification parameter Certⱼ is computed as Certⱼ=h(PEVⱼ∥PK_{EVj}∥Xⱼ∥PK_{TA})·xⱼ+s. The TA then sends {PEVⱼ, Certⱼ, Xⱼ} to EVⱼ through a secure channel. Upon receiving the information from the TA, EVⱼ verifies the correctness of the identity verification parameter Certⱼ by Certⱼ·P=h(PEVⱼ∥PK_{EVj}∥Xⱼ∥PK_{TA})·Xⱼ+PK_{TA}. If the result is incorrect, EVⱼ initiates a new registration request. If the equation is correct, it indicates that the received message is valid. EVⱼ randomly selects a challenge value Cⱼ and generates the corresponding response value Rⱼ=PUF (Cⱼ) using a physical unclonable function (PUF). The parameter Auth₁=h(ID_{EVj}∥aᵢ) mod n₀ is computed for driver login verification. VXᵢ=(X_{Xj}∥Y_{Xj}) ⊕ h (1∥Rⱼ) is used to encrypt and store the verification parameter Xⱼ (where (X_{Xj}, Y_{Xj}) represents the X and Y coordinates of Xⱼ). VPⱼ=PEVⱼ ⊕ h(2∥Rⱼ) is used to encrypt and store the pseudonym PEVⱼ.Fⱼ=Certⱼ ⊕ h(3∥Rⱼ) is used to encrypt and store the legitimacy verification parameter Certⱼ for vehicle identity. Vⱼ=vⱼ ⊕ h(4∥Rⱼ) is used to encrypt and store the long-term private key vⱼ. Here, n₀ ∈ (16, 256). Finally, the vehicle stores <Cⱼ, Rep(·), PK_{Evj}, Fⱼ, VXⱼ, Vⱼ, βᵢ, VPⱼ, Auth₁, n₀> in the onboard unit (OBU).

Furthermore, the specific details of S3 are as follows:

S3.1, before entering the nearest RSU₁ domain, the driver Drᵢ, enters identity ID_{Evj} and biometric information BIO*ⱼ, the emergency vehicle EVⱼ retrieves the biological key {a*ᵢ}=Rep(BIO*ᵢ), βᵢ) and computes and verifies the login verification parameter h(ID_{Evj}∥a*ᵢ) mod n₀ [symbol] Auth₁ to check if it is correct. If it is incorrect, the driver needs to re-login until the login threshold is reached. If it is correct, the driver's identity is successfully authenticated. The emergency vehicle EVⱼ calculates the response value Rⱼ=PUF(Cⱼ), the verification parameter (Xₓⱼ∥Yₓⱼ)=VXⱼ ⊕ h(1∥Rⱼ), the pseudonym PEVⱼ=VPⱼ ⊕ h(2∥Rⱼ), the identity verification parameter Certⱼ=Fⱼ ⊕ h(3∥Rⱼ), and the vehicle's long-term private key vⱼ=Vⱼ ⊕ h(4∥Rⱼ). The vehicle also randomly selects two random numbers r₁ and nⱼ, where r₁, nⱼ ∈ Z*_{q}, and computes A₁=r₁·P, A₂=nⱼ ⊕ h((r₁·PK_{RSU1})∥ 1) for encrypting and transmitting the random value nⱼ. Similarly, A₃=M ⊕ h((r₁·PK_{RSU1})∥ 2) is used for encrypting and transmitting the planned route M, A₄=(X_{Xj}∥Y_{Xj})⊕ h((r₁·PK_{RSU1})∥ 3) is used for encrypting and transmitting the verification parameter Xⱼ, A₅=(X_{PKJ}∥Y_{PKj})⊕ h((r₁·PK_{RSU1})∥4) is used for encrypting and transmitting the vehicle's public key PK_{EVj}, and A₆=PEVⱼ ⊕ h((r₁·PK_{RSU1})∥5) is used for encrypting and transmitting the vehicle's pseudonym PEVⱼ. The vehicle calculates the vehicle identity authentication parameter Auth₂=h(Xⱼ∥PK_{EVj}∥PEVⱼ∥M∥nⱼ∥T₂)·vⱼ+Certⱼ, where T₂ is the current timestamp, (X_{PKj}, Y_{PKj}) represents the X and Y coordinates of PEVⱼ. Then, the emergency vehicle EVⱼ sends {Auth₂, A₁, A₂, A₃, A₄, A₅, A₆, T₂} to the nearest roadside unit RSU₁.

S3.2, when receiving a message from the emergency vehicle EVⱼ, the roadside unit RSU₁ first checks the timestamp T₂. Then, RSU₁ calculates the response value R₁=PUF(C₁), computes the private key u₁=sk_{RSU1} ⊕ h(R₁∥T_{R1}), the random value nⱼ=A₂ ⊕ h((u₁·A₁)∥1) and the planned route M=A₃ ⊕ h((u₁·A₁)∥2), computes the verification parameters (Xₓⱼ∥Yₓⱼ)=A₄ ⊕h((u₁·A₁)∥3), the vehicle public key (X_{PKj}∥Y_{PKj})=A₅ ⊕ h((u₁·A₁)∥4), the vehicle pseudonym PEVⱼ=Ap₆ ⊕ h((u₁·A₁)∥5), and verifies if Auth₂·P [symbol] h (Xⱼ∥PK_{EVj}∥PEVⱼ∥M∥nⱼ∥T₂)·PK_{Evj}+h(PEVⱼ∥PK_{EVj}∥Xⱼ∥PK_{TA})·Xⱼ+PK_{TA}. If it is incorrect, the authentication will be terminated immediately. Otherwise, RSU₁ broadcasts the accident rescue route information to all regular vehicles within its jurisdiction. Additionally, RSU₁ generates two random numbers yⱼ₁₁, yⱼ₁₂ ∈ Z*_{q} and calculates Zⱼ₁=(yⱼ₁₁∥yⱼ₁₂)⊕ h(u₁·A₁∥nⱼ), Auth₃=h(nⱼ∥Zⱼ₁∥yⱼ₁₁∥yⱼ₁₂∥A₁∥Xⱼ∥T₃), then sends {Auth₃, Zⱼ₁, T₃} to the emergency vehicle EVⱼ. Furthermore, RSU₁ calculates Zₙ₁=Eₕ₍ᵤ_{₁}_{·PK}_{_{RSU2}}₎(PEVⱼ∥M∥yⱼ₁₁∥yⱼ₁₂∥T₃) based on elliptic curve Diffie-Hellman value, hash algorithm, and symmetric encryption algorithm for encrypting the transmission of the planned route M, shared secret values yⱼ₁₁ and yⱼ₁₂, and vehicle's pseudonym PEVⱼ. RSU₁ sends {PK_{RSU1}, Zₙ₁, T₃} to the next roadside unit RSU₂ through an open channel.

S3.3, after receiving a message from the nearest roadside unit RSU₁, the emergency vehicle EVⱼ first checks the timestamp T₃. Then, based on elliptic curve algorithm and hash algorithm, it calculates two shared secret values yⱼ₁₁∥yⱼ₁₂=Zⱼ₁ ⊕ h(r₁·PK_{RSU1}∥nⱼ). It also computes and checks if h(nⱼ∥Zⱼ₁∥yⱼ₁₁∥yⱼ₁₂∥A₁∥Xⱼ∥T₃) [symbol] Auth₃. If the equation holds, mutual authentication is successful, and the two parameters <yⱼ₁₁, yⱼ₁₂> are stored. Otherwise, EVⱼ resends the authentication request.

S3.4, after receiving a message from RSU₁, the roadside unit RSU₂ first checks the freshness of timestamp T₃ and calculates R₂=PUF(C₂), u₂=sk_{RSU2} ⊕ h(R₂∥T_{R2}), (PEVⱼ∥M∥yⱼ₁₁∥yⱼ₁₂∥T₃)=Dₕ₍ᵤ_{₂}_{·PK}_{_{RSU1}}₎(Zₙ₁), Qⱼ₁=yⱼ₁₂ ⊕ h(R₂∥yⱼ₁₁). Lastly, RSU₂ stores <yⱼ₁₁, Qⱼ₁, PEVⱼ, M> in the storage unit and broadcasts the accident rescue route information to all regular vehicles in that area in advance. Finally, it waits for EVⱼ to arrive in the domain for authentication.

Furthermore, the specific details of S4 are as follows:

S4.1, when the emergency vehicle EV arrives within the domain of the second roadside unit RSU₂, it first generates a random number r₂ ∈ Z*_{q}. Then, calculates A₇=r₂·P, Auth₄=h(yⱼ₁₁∥yⱼ₁₂∥PEVⱼ∥M∥A₇∥T₄) and sends {Auth₄, yⱼ₁₁, A₇, T₄} to RSU₂. Upon receiving a message from EVⱼ, RSU₂ first checks the freshness of timestamp T₄. RSU₂ retrieves <yⱼ₁₁, Qⱼ₁, PEVⱼ, M> from the database based on yⱼ₁₁. It calculates the response value R₂=PUF(C₂) and decrypts the shared secret value yⱼ₁₂=Qⱼ₁ ⊕ h(R₂∥yⱼ₁₁). It checks if Auth*₄=h(yⱼ₁₁∥yⱼ₁₂∥PEVⱼ∥M∥A₇∥T₄) is equal to Auth₄. If the equation holds, the authentication is successful, and RSU₂ generates two random numbers yⱼ₂₁, yⱼ₂₂ ∈ Z*_{q}. It computes Zⱼ₂=(yⱼ₂₁∥yⱼ₂₂)⊕ h(u₂·A₇∥T₅), Auth₅=h(Zⱼ₂∥yⱼ₂₁∥yⱼ₂₂∥yⱼ₁₂∥T₅), Zₙ₂=Eₕ₍ᵤ_{₂}_{·PK}_{_{RSU3}}₎(PEVⱼ∥M∥yⱼ₂₁∥yⱼ₂₂), and sends {Auth₅, Zⱼ₂, T₅} to EVⱼ and sends {PK_{RSU2}, Zₙ₂, T₅} to RSU₃, where RSU₃ is the subsequent roadside unit after RSU₂ in the planned route M.

S4.2, upon receiving a message from RSU₂, EVⱼ first checks the freshness of timestamp T₅ and calculates two shared secret values (yⱼ₂₁∥yⱼ₂₂)=Zⱼ₂ ⊕ h(r₂·PK_{RSU2}∥T₅) and the integrity parameter Auth*₅=h(Zⱼ₂∥yⱼ₂₁∥yⱼ₂₂∥yⱼ₁₂∥T₅). Then, it compares Auth*₅ with Auth₅. If they are equal, mutual authentication is successful. Otherwise, the emergency vehicle EVⱼ resends the authentication request. Similarly, upon receiving a message from RSU₂, the roadside unit RSU₃ first checks the timestamp T₅. It calculates the response value R₃=PUF (C₃) and recovers the long-term key u₃=sk_{RSU3} ⊕ h(R₃∥T_{R3}). It decrypts (PEVⱼ∥M∥yⱼ₂₁∥yⱼ₂₂∥T₅)=Dₕ₍ᵤ_{₃}_{·PK}_{_{RSU2)}}(Zₙ₂), computes Qⱼ₂=yⱼ₂₂ ⊕ h(R₃∥yⱼ₂₁), RSU₃ stores <yⱼ₂₁, Qⱼ₂, PEVⱼ, M> in the storage unit and broadcasts the avoidance message to all regular vehicles in that domain in advance. Finally, it waits for the emergency vehicle EVⱼ to arrive in the domain for authentication.

S4.3, the subsequent authentication methods are the same as the second authentication method described above, until the emergency vehicle reaches the accident scene.

Furthermore, the specific method for validating the timestamp is as follows:

$$\vert {T}_{n}^{′} - {T}_{n} \vert \leq Δ T$$

Where Tₙ is the timestamp included in the message received in the previous phase,

$${T}_{n}^{′}$$

is the current timestamp obtained by the device upon receiving the message, and ΔT is the threshold time allowed during the predetermined communication process. If the time difference exceeds the threshold time, the authentication process is terminated. If the time difference is less than the threshold time, the next step is carried out.

The authentication method for avoiding emergency vehicles as claimed in claim 1 is characterized by the transmission of all messages within the public channel. Furthermore, all messages are both transmitted over an open channel.

Compared to existing technologies, the proposed invention has the following advantages:

The invention solves the problem of emergency avoidance of other vehicles when the emergency vehicle arrives at the scene, so that the emergency vehicle can quickly arrive at the accident scene.

In the proposed invention, both the communication between emergency vehicles and roadside units, as well as the communication between roadside units, undergo a mutual authentication process. This ensures the legitimacy and traceability of the identities of the authenticated parties.

The proposed invention employs a method based on physical unclonable functions and biometric keys to protect the private keys of roadside units (RSUs) and emergency vehicles (EVs) when facing common attack methods such as message forgery, tampering, malicious tracking, and physical attacks. The design incorporates various encryption techniques, such as elliptic curve encryption algorithms and elliptic curve Diffie-Hellman values, along with timestamps and pseudonyms. This robust design effectively resists common attacks and physical breaches. Compared to traditional methods that rely on conventional alarm systems and visual cues, the proposed invention enhances the avoidance efficiency and reduces rescue delays. By broadcasting avoidance information in advance, it provides ordinary vehicles with ample time to take evasive actions. This improvement allows for a more efficient and timely avoidance process compared to traditional methods

The proposed invention employs elliptic curve cryptography, which have the advantages of short key length, high strength, few parameters, fast digital signature generation, and small computational requirements. This makes them particularly suitable for devices with limited computing and storage resources.

### BRIEF DESCRIPTION OF DRAWINGS

The accompanying drawings generally illustrate various embodiments by way of example and not limitation, and are provided in conjunction with the specification and claims to describe the embodiments of the invention. Where appropriate, like reference numerals are used in all the drawings to refer to the same or similar parts. Such embodiments are illustrative and not intended to be exhaustive or exclusive implementations of the device or method.

FIG. 1 illustrates the system architecture diagram.

FIG. 2 illustrates the flow chart of the first communication certification between the vehicle and the roadside unit.

FIG. 3 illustrates the flow chart of message propagation between roadside units and roadside units.

FIG. 4 illustrates the communication authentication flow chart between the vehicle and the subsequent roadside unit.

### DETAILED DESCRIPTION OF EMBODIMENTS

It should be noted that, unless conflicting, the embodiments and features described in the present application can be combined with each other. The following detailed description of the present application will refer to the accompanying drawings and incorporate the embodiments for further explanation.

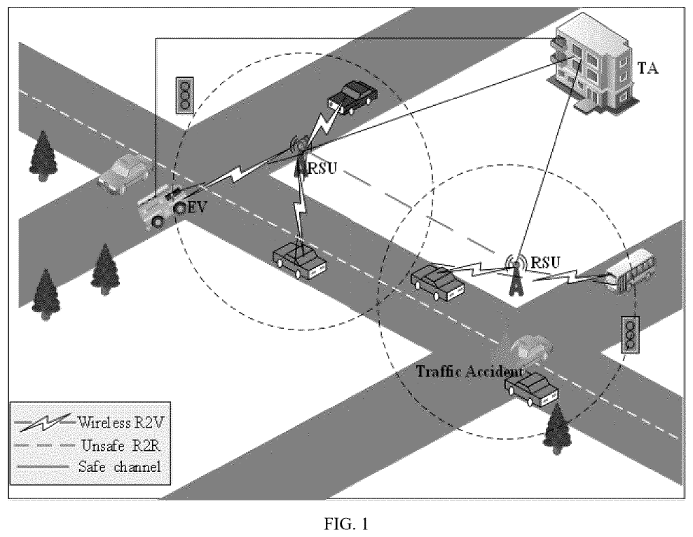

As shown in FIG. 1, an authentication method for avoiding emergency vehicles is implemented based on three entities: vehicles, a trusted authority (TA), and roadside units (RSUs). The trusted authority (TA) is responsible for registering other entities (i.e., emergency vehicles (EVs) and roadside units (RSUs)) in the network and distributing keys to them. Meanwhile, when an emergency vehicle does not have an emergency task, it can use the emergency lane, and the trusted authority (TA) can identify the vehicle and hold the driver accountable. The roadside units (RSUs) are responsible for anonymously authenticating emergency vehicles and issuing avoidance information to regular vehicles. They also transmit the emergency vehicle's identity and partial information to the next RSU along the planned route. To ensure the system's integrity, it is assumed that the communication channels between RSUs are not entirely secure. Emergency vehicles communicate with RSUs through an open channel using the Dedicated Short-Range Communication (DSRC) protocol.

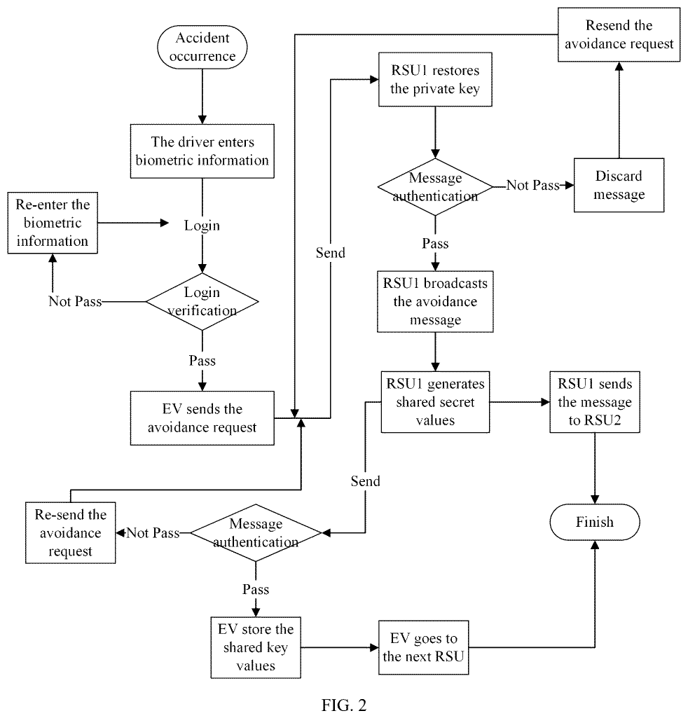

As shown in FIG. 2, the specific process of initial communication authentication between vehicles and roadside units is as follows:

After an accident occurs, the driver of the emergency vehicle enters their biometric information for login verification. If the verification fails, they can retry entering the biometric information until reaching the login attempts threshold. If successful, the driver's identity is authenticated. The emergency vehicle then sends an avoidance request message to the nearest roadside unit (RSU₁). The RSU₁ recovers its private key and verifies the message. If the authentication fails, the RSU₁ discards the message, and the vehicle resends the avoidance request. If the authentication passes, the RSU₁ sends the avoidance information to all regular vehicles within its jurisdiction for timely avoidance. It also generates shared secret values encrypted and sent to the emergency vehicle. The emergency vehicle performs message authentication using the shared secret values. If the authentication fails, the vehicle resends the avoidance request message. If the authentication passes, the vehicle stores the shared secret values and proceeds quickly to the next roadside unit. Simultaneously, the nearest RSU (RSU₁) sends a message to the second roadside unit (RSU₂), facilitating fast authentication switching.

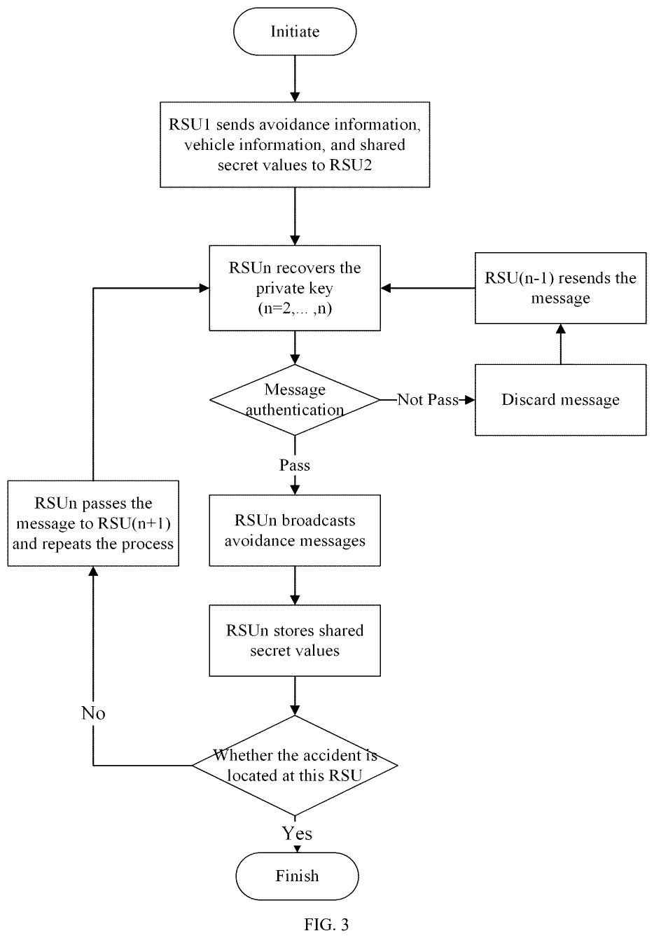

As shown in FIG. 3, the specific process of message propagation between roadside units is as follows:

The nearest roadside unit (RSU₁) passes the avoidance message, partial information of the emergency vehicle, and the shared secret values to the second roadside unit (RSU₂) located along the rescue route. Upon receiving the message, RSU₂ performs authentication. If the authentication fails, RSU₁ resends the message. If the authentication passes, RSU₂ notifies the regular vehicles within its jurisdiction to make early avoidance preparations. It also stores the shared secret values and prepares to assist the emergency vehicle. If RSU₂ is not the roadside unit at the accident location, the avoidance message and shared secret values will be further propagated to the next roadside unit (RSU₃). The process is repeated, including authentication, notification to regular vehicles, storage of the shared secret values, and preparation to assist the emergency vehicle. This propagation process continues until reaching the roadside unit (RSU) at the accident location.

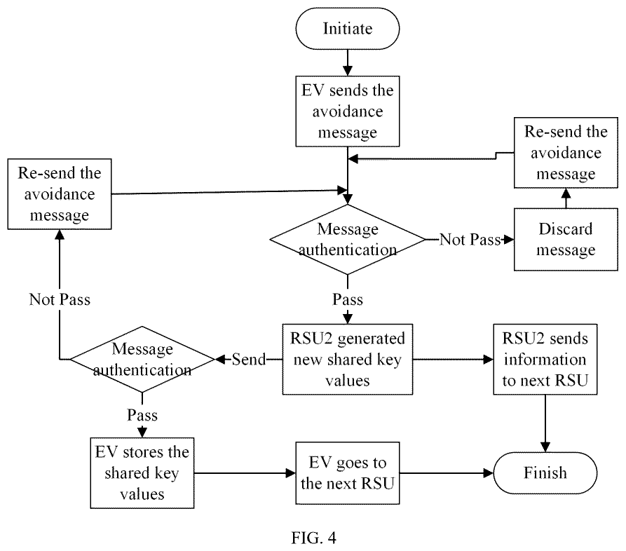

As shown in FIG. 4, the specific process of subsequent message authentication is as follows:

When the emergency vehicle (EV) reaches the jurisdiction of the second roadside unit (RSU₂), it sends a request for authentication information to RSU₂. RSU₂ authenticates the vehicle. Upon successful authentication, RSU₂ generates new shared secret values, encrypts them, and sends them to the emergency vehicle. The emergency vehicle performs message authentication using the new shared secret values. If the authentication fails, the vehicle resends the avoidance request message. If the authentication passes, the vehicle stores the new shared secret values and proceeds quickly to the next roadside unit. The subsequent authentication process follows the same method as the second authentication described above. This process continues until the emergency vehicle reaches the accident scene.

The above description represents a preferred embodiment of the invention. However, the scope of the invention is not limited to this embodiment. Those skilled in the art, within the technical scope disclosed by the invention, can make equivalent substitutions or changes based on the technical solution and inventive concept of the invention. Such substitutions or changes should also be encompassed within the scope of the invention.

What is claimed is:

1. Authentication method for avoiding emergency vehicles, characterized by the following:
S1, during the system initialization phase, the trusted authority (TA) selects an elliptic curve, generates public and private keys, and handles registration requests from emergency vehicles and roadside units;
S2, the trusted authority (TA) is responsible for generating registration information for both emergency vehicles and roadside units, and providing feedback of the registration information to the vehicles and roadside units. Upon receiving the registration information, the vehicles and roadside units utilize their unique physical unclonable functions to calculate secret parameters. The calculated registration information is then separately stored in the onboard unit (OBU) of the vehicle and the storage unit of the roadside unit;
S3, after an accident occurs, the emergency vehicle proactively sends accident rescue route information and an authentication request to the nearest roadside unit. Upon receiving the message, the roadside unit first verifies the legitimacy of the vehicle's identity. If the authentication is successful, the roadside unit sends the avoidance message in advance to all regular vehicles within its jurisdiction, prompting them to make timely evasive maneuvers and clear the emergency lane. Simultaneously, the roadside unit generates shared secret values, encrypts them, and sends them to the emergency vehicle. This is achieved using elliptic curve Diffie-Hellman (ECDH) values, hash algorithms, and symmetric encryption algorithms. Additionally, the roadside unit transmits the avoidance message, partial vehicle information, and the shared secret values to the next roadside unit along the rescue route;
S4, when the emergency vehicle reaches the second roadside unit, it sends an authentication request to the roadside unit. The second roadside unit performs the authentication process, and upon successful authentication, generates new shared secret values. This new shared secret values are encrypted and sent to the emergency vehicle. Simultaneously, the second roadside unit passes on the avoidance message, partial vehicle information, and the newly generated shared secret values to the next roadside unit along the rescue route. This process continues until the emergency vehicle reaches the accident scene.

2. The authentication method for avoiding emergency vehicles according to claim 1, characterized in that a random number s ∈ Z*_{q} is selected as the private key of the system, and the corresponding public key is computed as the point multiplication result using the elliptic curve algorithm, denoted as PK_{TA}=s·P.

3. The authentication method for avoiding emergency vehicles according to claim 1, characterized in that S2 is specifically as follows:
S2.1, Roadside Unit Registration. Firstly, the trusted authority (TA) generates timestamps T_{Rn}={T_{R1}, T_{R2} . . . , T_{Rn}} for each roadside unit RSUₙ={RSU₁, RSU₂, RSU₃, . . . , RSUₙ}. Simultaneously, it selects private keys uₙ ∈ Z*_{q} for each roadside unit and computes the corresponding public keys PK_{RSUn}=uₙ·P using elliptic curve point multiplication. Next, the TA sends the private key uₙ, public key PK_{RSUn}, and timestamp T_{Rn} to each roadside unit RSUₙ. The roadside unit RSUₙ randomly selects a challenge value Cₙ and uses a physical unclonable function (PUF) to generate the corresponding response value Rₙ=PUF(Cₙ). It then computes sk_{RSUn}=uₙ ⊕ h(Rₙ∥T_{Rn}) to encrypt and store the long-term private key uₙ. Finally, the roadside unit stores the tuple <Cₙ, sk_{RSUn}, PK_{RSUn}, T_{Rn}> in its storage unit. Meanwhile, the TA publishes the system parameters params={G, E, P, p, q, a, b, h(·), PK_{TA}, PK_{RSUn}} for all entities;
S2.2, Emergency Vehicle and Driver Registration. The driver Drᵢ of the emergency vehicle EVⱼ selects an identity ID_{EVj} and inputs his/her biometric information BIOᵢ to EVⱼ. EVⱼ generates its private key vⱼ ∈ Z*_{q} and computes the public key PK_{EVj}=vⱼ·P using elliptic curve algorithm. Using the fuzzy extractor's generation function Gen(BIOᵢ)={aᵢ, βᵢ}, the biological key αᵢ and recovery parameter βᵢ are computed. EVⱼ sends {PK_{EVj}, ID_{EVj}} to the trusted authority (TA) through a secure channel. The TA generates the current timestamp T₁, two random numbers xⱼ and bⱼ, and computes Xⱼ=xⱼ·P using elliptic curve algorithm. Using the system key s, it encrypts and generates the pseudonym of the emergency vehicle EVⱼ as PEVⱼ=Eₛ(ID_{EVj}∥bⱼ∥T₁). The identity verification parameter Certⱼ is computed as Certⱼ=h(PEVⱼ∥PK_{Evj}∥Xⱼ∥PK_{TA})·xⱼ+s. The TA then sends {PEVⱼ, Certⱼ, Xⱼ} to EVⱼ through a secure channel. Upon receiving the information from the TA, EVⱼ verifies the correctness of the identity verification parameter Certⱼ by Certⱼ·P=h(PEVⱼ∥PK_{EVj}∥Xⱼ∥PK_{TA})·Xⱼ+PK_{TA}. If the result is incorrect, EVⱼ initiates a new registration request. If the equation is correct, it indicates that the received message is valid. EVⱼ randomly selects a challenge value Cⱼ and generates the corresponding response value Rⱼ=PUF(Cⱼ) using a physical unclonable function (PUF). The parameter Auth₁=h(ID_{EVj}∥aᵢ) mod n₀ is computed for driver login verification. VXⱼ=(X_{Xj}∥Y_{Xj})⊕ h(1∥Rⱼ) is used to encrypt and store the verification parameter Xⱼ (where (X_{Xj}, Y_{Xj}) represents the X and Y coordinates of Xⱼ). VPⱼ=PEVⱼ ⊕ h(2∥Rⱼ) is used to encrypt and store the pseudonym PEVⱼ. Fⱼ=Certⱼ ⊕ h(3∥Rⱼ) is used to encrypt and store the legitimacy verification parameter Certⱼ for vehicle identity. Vⱼ=vⱼ ⊕ h(4∥Rⱼ) is used to encrypt and store the long-term private key vⱼ. Here, n₀ ∈ (16, 256). Finally, the vehicle stores <Cⱼ, Rep (·), PK_{Evj}, Fⱼ, VXⱼ, Vⱼ, βᵢ, VPⱼ, Auth₁, n₀>in the onboard unit (OBU).

4. The authentication method for avoiding emergency vehicles according to claim 1, characterized in that S3 is specifically:
S3.1, before entering the nearest RSU₁ domain, the driver Drᵢ, enters identity ID_{EVj} and biometric information BIO*ᵢ, the emergency vehicle EVⱼ retrieves the biological key {a*ᵢ}=Rep(BIO*ᵢ, βᵢ) and computes and verifies the login verification parameter h(ID_{Evj}∥a*ᵢ) mod n₀ [symbol] Auth₁ to check if it is correct. If it is incorrect, the driver needs to re-login until the login threshold is reached. If it is correct, the driver's identity is successfully authenticated. The emergency vehicle EVⱼ calculates the response value Rⱼ=PUF (Cⱼ), the verification parameter (Xₓⱼ∥Yₓⱼ)=VXⱼ ⊕ h(1∥Rⱼ), the pseudonym PEVⱼ=VPⱼ ⊕ h(2∥Rⱼ), the identity verification parameter Certⱼ=Fⱼ ⊕ h(3∥Rⱼ), and the vehicle's long-term private key vⱼ=Vⱼ ⊕ h(4∥Rⱼ). The vehicle also randomly selects two random numbers r₁ and nⱼ, where r₁, nⱼ ∈ Z*_{q}, and computes A₁=r₁·P, A₂=nⱼ ⊕ h((r₁·PK_{RSU1})∥1) for encrypting and transmitting the random value nⱼ. Similarly, A₃=M ⊕ h((r₁·PK_{RSU1})∥2) is used for encrypting and transmitting the planned route M, A₄=(X_{Xk}∥Y_{Xj}) ⊕ h((r₁·PK_{RSU1})∥3) is used for encrypting and transmitting the verification parameter Xⱼ, A₅=(X_{PKj}∥Y_{PKj}) ⊕ h((r₁·PK_{RSU1})∥4) is used for encrypting and transmitting the vehicle's public key PK_{EVj}, and A₆=PEVⱼ ⊕ h((r₁·PK_{RSU1})∥5) is used for encrypting and transmitting the vehicle's pseudonym PEVⱼ. The vehicle calculates the vehicle identity authentication parameter Auth₂=h(Xⱼ∥PK_{EVj}∥PEVⱼ∥M∥nⱼ∥T₂)·vⱼ+Certⱼ, where T₂ is the current timestamp, (X_{PKj}, Y_{PKj}) represents the X and Y coordinates of PEVⱼ. Then, the emergency vehicle EVⱼ sends {Auth₂, A₁, A₂, A₃, A₄, A₅, A₆, T₂} to the nearest roadside unit RSU₁;
S3.2, when receiving a message from the emergency vehicle EVⱼ, the roadside unit RSU₁ first checks the timestamp T₂. Then, RSU₁ calculates the response value R₁=PUF(C₁), computes the private key u₁=sk_{RSU1} ⊕ h(R₁∥T_{R1}), the random value nⱼ=A₂ ⊕ h((u₁·A₁)∥1) and the planned route M=A₃ ⊕ h((u₁·A₁)∥2), computes the verification parameters (Xₓⱼ∥Yₓⱼ)=A₄ ⊕ h((u₁·A₁)∥3), the vehicle public key (X_{PKj}∥Y_{PKj})=A₅ ⊕ h((u₁·A₁)∥4), the vehicle pseudonym PEVⱼ=A₆ ⊕ h((u₁·A₁)∥5), and verifies if Auth₂·P [symbol] h(Xⱼ∥PK_{Evj}∥PEVⱼ∥M∥nⱼ∥T₂)·PK_{EVj}+h(PEVⱼ∥PK_{EVj}∥Xⱼ∥PK_{TA})·Xⱼ+PK_{TA}. If it is incorrect, the authentication will be terminated immediately. Otherwise, RSU₁ broadcasts the accident rescue route information to all regular vehicles within its jurisdiction. Additionally, RSU₁ generates two random numbers yⱼ₁₁, yⱼ₁₂ ∈ Z*_{q} and calculates Zⱼ₁=(yⱼ₁₁∥yⱼ₁₂)⊕ h(u₁·A₁∥nⱼ), Auth₃=h(nⱼ∥Zⱼ₁∥yⱼ₁₁∥yⱼ₁₂∥A₁∥Xⱼ∥T₃), then sends {Auth₃, Zⱼ₁, T₃} to the emergency vehicle EVⱼ. Furthermore, RSU₁ calculates Zₙ₁=Eₕ₍ᵤ_{₁}_{·PK}_{_{RSU2}}₎(PEVⱼ∥M∥yⱼ₁₁∥yⱼ₁₂∥T₃) based on elliptic curve Diffie-Hellman value, hash algorithm, and symmetric encryption algorithm for encrypting the transmission of the planned route M, shared secret values yⱼ₁₁ and yⱼ₁₂, and vehicle's pseudonym PEVⱼ. RSU₁ sends {PK_{RSU1}, Zₙ₁, T₃} to the next roadside unit RSU₂ through an open channel;
S3.3, after receiving a message from the nearest roadside unit RSU₁, the emergency vehicle EVⱼ first checks the timestamp T₃. Then, based on elliptic curve algorithm and hash algorithm, it calculates two shared secret values yⱼ₁₁∥yⱼ₁₂=Zⱼ₁ ⊕ h(r₁·PK_{RSU1}∥nⱼ). It also computes and checks if h(nⱼ∥Zⱼ₁∥yⱼ₁₁∥yⱼ₁₂∥A₁∥Xⱼ∥T₃) [symbol] Auth₃. If the equation holds, mutual authentication is successful, and the two parameters <yⱼ₁₁, yⱼ₁₂> are stored. Otherwise, EVⱼ resends the authentication request;
S3.4, after receiving a message from RSU₁, the roadside unit RSU₂ first checks the freshness of timestamp T₃ and calculates R₂=PUF(C₂), u₂=sk_{RSU2} ⊕ h(R₂∥TR₂), (PEVⱼ∥M∥yⱼ₁₁∥yⱼ₁₂∥T₃)=Dₕ₍ᵤ_{₂}_{·PK}_{_{RSU1}}₎(Zₙ₁), Qⱼ₁=yⱼ₁₂ ⊕ h(R₂∥yⱼ₁₁). Lastly, RSU₂ stores <yⱼ₁₁, Qⱼ₁, PEVⱼ, M>in the storage unit and broadcasts the accident rescue route information to all regular vehicles in that area in advance. Finally, it waits for EVⱼ to arrive in the domain for authentication.

5. The authentication method for avoiding emergency vehicles according to claim 1, characterized in that S4 is specifically:
S4.1, when the emergency vehicle EVⱼ arrives within the domain of the second roadside unit RSU₂, it first generates a random number r₂ ∈ Z*_{q}. Then, calculates A₇=r₂·P, Auth₄=h(yⱼ₁₁ ∥yⱼ₁₂ ∥PEVⱼ ∥M ∥A₇ ∥T₄) and sends {Auth₄, yⱼ₁₁, A₇, T₄} to RSU₂. Upon receiving a message from EVⱼ, RSU₂ first checks the freshness of timestamp T₄. RSU₂ retrieves <yⱼ₁₁, Qⱼ₁, PEVⱼ, M> from the database based on yⱼ₁₁. It calculates the response value R₂=PUF (C₂) and decrypts the shared secret value yⱼ₁₂=Qⱼ₁ ⊕h(R₂ ∥yⱼ₁₁). It checks if Auth*₄=h(yⱼ₁₁∥yⱼ₁₂∥PEVⱼ∥M∥A₇∥T₄) is equal to Auth₄. If the equation holds, the authentication is successful, and RSU₂ generates two random numbers yⱼ₂₁, yⱼ₂₂ ∈ Z*_{q}. It computes Zⱼ₂=(yⱼ₂₁∥yⱼ₂₂)⊕ h(u₂·A₇∥T₅), Auth₅=h(Zⱼ₂∥yⱼ₂₁∥yⱼ₂₂∥yⱼ₁₂∥T₅), Zₙ₂=Eₕ₍ᵤ_{₂}_{·PK}_{_{RSU3}}₎(PEVⱼ∥M∥yⱼ₂₁∥yⱼ₂₂), and sends {Auth₅, Zⱼ₂, T₅} to EVⱼ and sends {PK_{RSU2}, Zₙ₂, T₅} to RSU3, where RSU₃ is the subsequent roadside unit after RSU₂ in the planned route M;
S4.2, upon receiving a message from RSU₂, EVⱼ first checks the freshness of timestamp T₅ and calculates two shared secret values (yⱼ₂₁∥yⱼ₂₂)=Zⱼ₂ ⊕ h(r₂·PK_{RSU2}∥T₅) and the integrity parameter Auth*₅=h(Zⱼ₂∥yⱼ₂₁∥yⱼ₂₂∥yⱼ₁₂∥T₅). Then, it compares Auth*₅ with Auth₅. If they are equal, mutual authentication is successful. Otherwise, the emergency vehicle EVⱼ resends the authentication request. Similarly, upon receiving a message from RSU₂, the roadside unit RSU₃ first checks the timestamp T₅. It calculates the response value R₃=PUF(C₃) and recovers the long-term key u₃=sk_{RSU3} ⊕ h(R₃∥T_{R3}). It decrypts (PEVⱼ∥M∥yⱼ₂₁∥yⱼ₂₂∥T₅)=Dₕ₍ᵤ_{₃}_{·PK}_{_{RSU}}₎(Zₙ₂), computes Qⱼ₂=yⱼ₂₂ ⊕ h(R₃∥yⱼ₂₁), RSU₃ stores <yⱼ₂₁, Qⱼ₂, PEVⱼ, M> in the storage unit and broadcasts the avoidance message to all regular vehicles in that domain in advance. Finally, it waits for the emergency vehicle EVⱼ to arrive in the domain for authentication;
S4.3, the subsequent authentication methods are the same as the second authentication method described above, until the emergency vehicle reaches the accident scene.

6. The authentication method for avoiding emergency vehicles according to claim 3, characterized in that the method for verifying timestamps is specifically:
$$\vert {T}_{n}^{′} - {T}_{n} \vert \leq Δ T$$
Where Tₙ is the timestamp included in the message received in the previous phase, T′ₙ is the current timestamp obtained by the device upon receiving the message, and ΔT is the threshold time allowed during the predetermined communication process. If the time difference exceeds the threshold time, the authentication process is terminated. If the time difference is less than the threshold time, the next step is carried out.

7. The authentication method for emergency vehicle avoidance according to claim 1, characterized in that all messages are transmitted through a public channel.
